(19) United States
(12) Patent Application Publication
(10) Pub. No.: US 2016/0302483 A1
(43) Pub. Date: Oct. 20, 2016

(54) ELECTRONIC CIGARETTE, BATTERY STATE DISPLAY STRUCTURE THEREOF, AND DISPLAY METHOD

(71) Applicant: KIMREE HI-TECH INC., RoadTown, Tortola (VG)

(72) Inventor: Qiuming LIU, Huizhou, Guangdong (CN)

(21) Appl. No.: 14/650,482

(22) PCT Filed: Nov. 8, 2013
(86) PCT No.: PCT/CN2013/086728

§ 371 Date: Jun. 8, 2015

(30) Foreign Application Priority Data
Oct. 25, 2013 (CN) 201320665943.7

(51) Int. Cl. A24F 47/00; G06F 1/28; H05B 33/08; H01M 10/48; H01M 10/42

(52) U.S. Cl. CPC A24F 47/002; H01M 10/488; H01M 10/425; H05B 33/0842; G06F 1/28; H01M 2220/30; H01M 2010/4271

(57) ABSTRACT

An electronic cigarette and a battery state display structure thereof. The battery state display structure comprises a light-emitting component and a control system. The light-emitting component is arranged at a battery rod (11) part of the electronic cigarette, comprising multiple light-emitting units arranged along the axial direction of the battery rod (11). The control system is electrically connected to a battery (13) of the electronic cigarette. Light-up positions of the light-emitting units of the light-emitting component are controlled by changes in the voltage or changes in the amperage of the battery (13) while the electronic cigarette is in use. This allows for intuitive display of the state of the battery (13) and allows a user to easily learn of the status of the battery (13) and to make reasonable planning for recharge and use.

The present application claims the priority to Chinese Patent Application No. 201320665943.7, titled “ELECTRONIC CIGARETTE, AND STRUCTURE AND METHOD FOR DISPLAYING BATTERY STATUS OF ELECTRONIC CIGARETTE”, filed with the State Intellectual Property Office of the People's Republic of China on Oct. 25, 2013, which is incorporated herein by reference in its entirety.

### FIELD

The present application relates to the field of electronic cigarette, and in particular, to an electronic cigarette, and a structure and a method for displaying a battery status of the electronic cigarette.

### BACKGROUND

Electronic cigarette, also called virtual cigarette and electronic atomizer, is mainly used in smoking cessation and cigarette substitution. The electronic cigarette has a same appearance and a similar flavor as cigarette, and the flavor of the electronic cigarette is even more intense than that of a general cigarette. During a suction of the electronic cigarette, smoke and flavor may be produced and a same experience as a suction of the cigarette may be realized.

Battery is an important component of the electronic cigarette and is a power source for a normal operation of the electronic cigarette. However, there is generally a lack of structures, which may visually reflect battery status, in conventional electronic cigarettes; hence, a user may not know clearly when to charge the electronic cigarette, thereby causing much inconvenience.

Therefore, in view of the above issue, how to visually display the battery status of the electronic cigarette is a technical problem to be solved by those skilled in the art.

### SUMMARY

Accordingly, a structure for displaying a battery status of an electronic cigarette is provided in the application, to visually display the battery status of the electronic cigarette, thereby improving user experience.

An electronic cigarette adopting the above structure for displaying the battery status is further provided in the application.

A method for displaying a battery status of an electronic cigarette is provided in the application, and the method is applicable to the above structure.

For achieving the above object, a technical solution provided in the present application is given as follows.

A structure for displaying a battery status of an electronic cigarette includes a light-emitting assembly and a control system.

The light-emitting assembly is arranged at a battery rod portion of the electronic cigarette and includes multiple light-emitting units arranged in an axial direction of the battery rod, where the multiple light-emitting units are for representing different electric quantities of a battery.

The control system is electrically connected to the battery of the electronic cigarette, and is for independently controlling lightings and extinguishings of the multiple the light-emitting units based on the battery status when the electronic cigarette operates.

Preferably, the control system includes a microprocessor, and an electric quantity monitoring module or a voltage monitoring module.

The electric quantity monitoring module or the voltage monitoring module is for, monitoring an electric quantity or a voltage of the battery and transmitting a monitored battery status signal to the microprocessor.

The microprocessor is for, receiving the battery status signal and controlling, based on the battery status signal, a lighting position of the light-emitting units of the light-emitting assembly.

Preferably, the control system further includes an airflow sensor.

The airflow sensor is for, monitoring a suction airflow of the electronic cigarette and transmitting a signal associated with the monitored airflow to the microprocessor.

The microprocessor is for, receiving the signal associated with the airflow, and controlling, in case of receiving the signal associated with the airflow, the lighting position of the light-emitting units of the light-emitting assembly based on the battery status signal monitored by the electric quantity monitoring module or the voltage monitoring module.

Preferably, the light-emitting assembly is arranged on an outer surface of the battery rod or is arranged between an inner wall of the battery rod and the battery of the electronic cigarette.

Preferably, the light-emitting assembly is a flexible lamp panel or a rigid lamp panel.

Preferably, the multiple light-emitting units are arranged into circles in a radial direction of the electronic cigarette.

Preferably, the light-emitting assembly is a scroll-like lamp panel arranged between the inner wall of the battery rod and the battery of the electronic cigarette, and multiple rows of LED lamps serving as the light-emitting units are arranged at the scroll-like lamp panel in an axial direction of the scroll-like lamp panel.

Preferably, the light-emitting assembly is a surround-like lamp panel arranged between the inner wall of the battery rod and the battery of the electronic cigarette, and multiple rows of LED lamps serving as the light-emitting units are arranged at the surround-like lamp panel in a length extending direction of the surround-like lamp panel.

Preferably, the light-emitting assembly includes a pcb lamp panel and multiple miniature lamps arranged in a length direction of the pcb lamp panel, and two sides of the pcb lamp panel are retainable in an installation groove provided on an inner wall of a lamp cap of the electronic cigarette.

Preferably, the light-emitting assembly further includes a lamp for simulating an ash end of a lighted cigarette, the lamp for simulating the ash end being arranged at a side of a lamp cap.

An electronic cigarette is provided, and the electronic cigarette includes the above structure for displaying the battery status of the electronic cigarette.

A method for displaying a battery status of an electronic cigarette includes:

a step S1 of monitoring the battery status of the electronic cigarette in case of detecting a switch-on of the electronic cigarette or detecting a suction airflow; and

a step S2 of controlling, based on the battery status, lightings and extinguishings of multiple light-emitting units arranged in a light-emitting assembly, the multiple light-emitting units being arranged in an axial direction of a battery rod and configured to represent different electric quantities of a battery, where an electric quantity of the battery represented by a light-emitting unit remote from a suction end of the electronic cigarette is larger than an electric quantity of the battery represented by a light-emitting unit close to the suction end of the electronic cigarette.

Preferably, controlling the lightings and extinguishings in the step S2 includes:
controlling a first group of light-emitting units farthest away from the suction end of the electronic cigarette to light up if the battery status is in a sufficient range,
controlling a second group of light-emitting units located in a middle portion of the light-emitting assembly to light up if the battery status is in a moderate range, and
controlling a third group of light-emitting units closest to the suction end of the electronic cigarette to light up if the battery status is in an inadequate range; and
preferably in the step S2, a brightness of a light emitted by the light-emitting unit remote from the suction end of the electronic cigarette is stronger than a brightness of a light emitted by the light-emitting unit close to the suction end of the electronic cigarette.

Preferably, in the step S2, multiple light-emitting units are circularly arranged in a radial direction of the electronic cigarette to form a group of light-emitting units, and the light-emitting assembly is provided with multiple groups of light-emitting units arranged in the axial direction of the battery rod.

As illustrated from the above technical solution, in the electronic cigarette and the structure for displaying the battery status of the electronic cigarette provided in the application, the light-emitting assembly is arranged in the battery rod portion of the electronic cigarette; the multiple light-emitting units are arranged along the axial direction of the battery rod, where the multiple light-emitting units are for representing different electric quantities of the battery; and the control system independently controls the lighting and extinguishing of the multiple light-emitting units based on the battery status while the electronic cigarette is working. Hence, the battery status of the electronic cigarette may be visually displayed, and a user may easily acquire a battery condition and perform a reasonable arrangement of charging and usage, thereby improving the user experience. The method for displaying the battery status of the electronic cigarette is further provided in the present application, where the method is visual, vivid and applicable to the foregoing structure.

### BRIEF DESCRIPTION OF THE DRAWINGS

For more clearly illustrating technical solutions according to embodiments of the present application or conventional technologies, drawings to be used in descriptions of the embodiments or the conventional technologies are briefly introduced hereinafter. Apparently, the drawings in the following descriptions are merely used to illustrate some embodiments of the present application, and those skilled in the art may achieve other drawings based on these drawings without any creative efforts.

FIG. 1 is a schematic view of a structure for displaying a battery status of an electronic cigarette according to a first embodiment of the application;

FIG. 2 is an explosive view of the structure for displaying the battery status of the electronic cigarette according to the first embodiment of the application;

FIG. 3 is a schematic view of a structure for displaying a battery status of an electronic cigarette according to a second embodiment of the application;

FIG. 4 is an explosive view of the structure for displaying the battery status of the electronic cigarette according to the second embodiment of the application;

FIG. 5 is a schematic view of a structure for displaying a battery status of an electronic cigarette according to a third embodiment of the application;

FIG. 6 is an explosive view of the structure for displaying the battery status of the electronic cigarette according to the third embodiment of the application; and

FIG. 7 is a schematic circuit diagram of an electronic cigarette provided in the application.

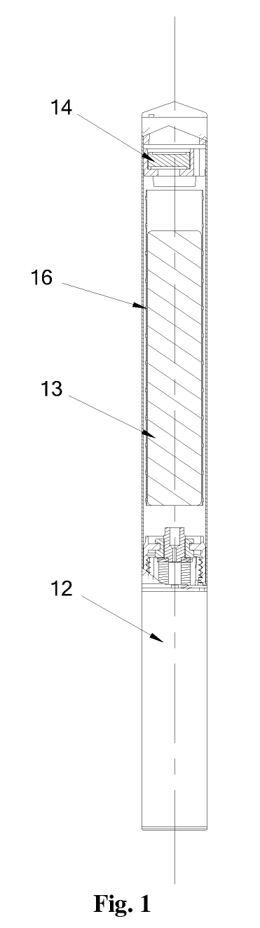

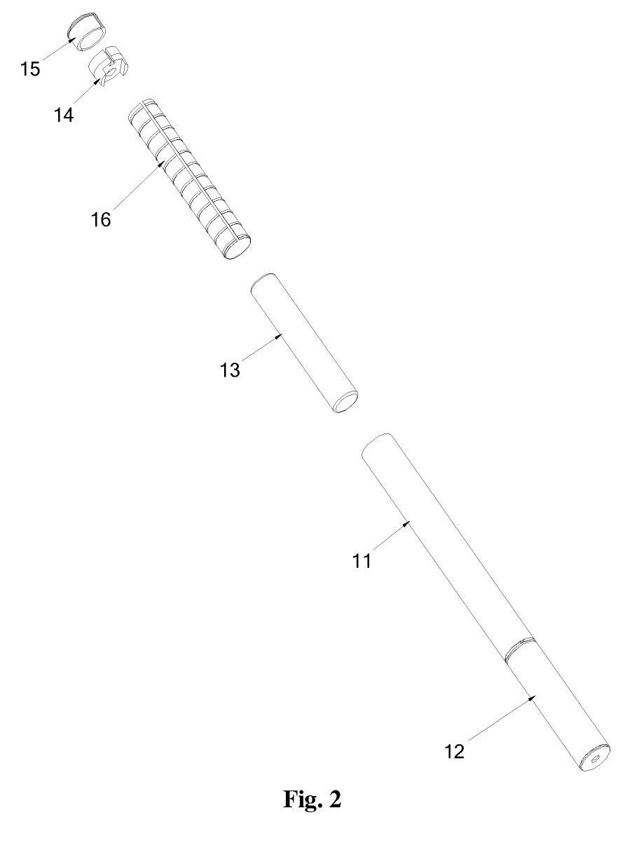

In FIGS. 1 and 2, reference numeral 11 represents a battery rod, reference numeral 12 represents an atomizer, reference numeral 13 represents a battery, reference numeral 14 represents a microphone assembly, reference numeral 15 represents a lamp cap, and reference numeral 16 represents a scroll-like lamp panel.

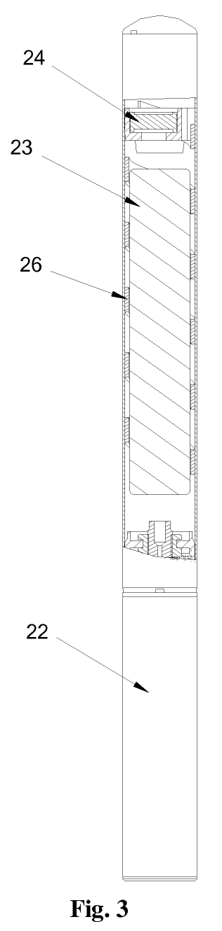

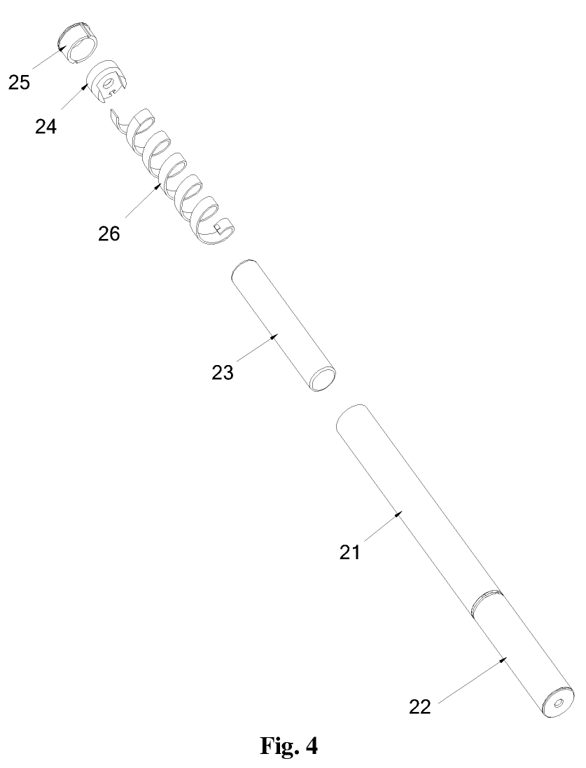

In FIGS. 3 and 4, reference numeral 21 represents a battery rod, reference numeral 22 represents an atomizer, reference numeral 23 represents a battery, reference numeral 24 represents a microphone assembly, reference numeral 25 represents a lamp cap, and reference numeral 26 represents a surround-like lamp panel.

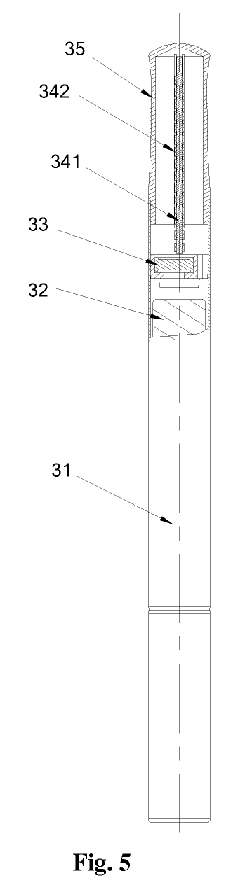

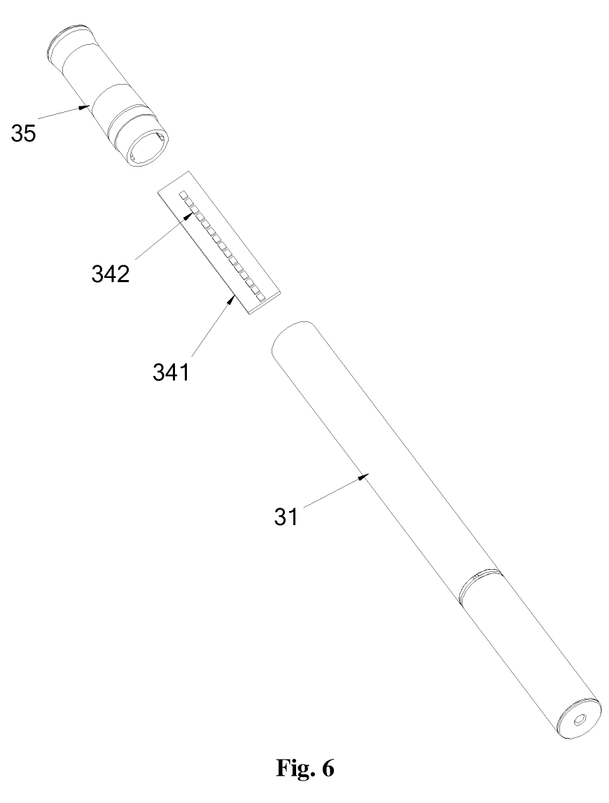

In FIGS. 5 and 6, reference numeral 31 represents an electronic cigarette, reference numeral 32 represents a battery, reference numeral 33 represents a microphone assembly, reference numeral 341 represents a pcb lamp panel, reference numeral 342 represents a miniature lamp, and reference numeral 35 represents a lamp cap.

### DETAILED DESCRIPTION OF THE EMBODIMENTS

The present application provides a structure for displaying a battery status of an electronic cigarette, to visually display the battery status of the electronic cigarette, thereby improving user experience.

Technical solutions in embodiments of the present application are described clearly and completely hereinafter in conjunction with drawings used in the embodiments of the present application. Apparently, the described embodiments are only a part of rather than all of the embodiments of the present application. Any other embodiments obtained by those skilled in the art without inventive efforts should fall in the scope of protection of the present application.

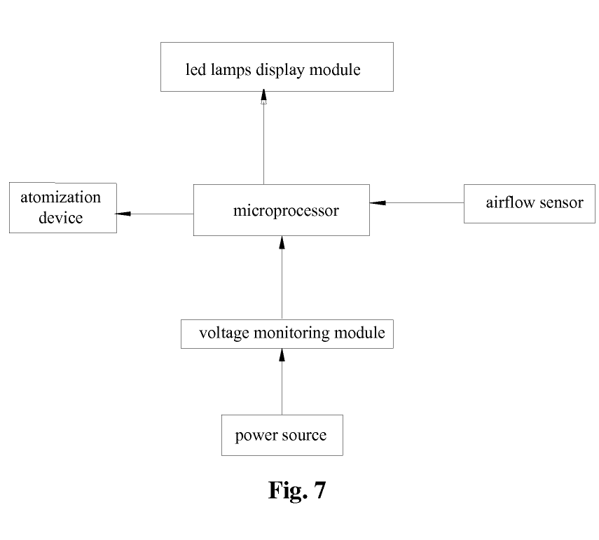

Reference may be made to FIGS. 1-7. FIGS. 1 and 2 are respectively a schematic view and an explosive view of a structure for displaying a battery status of an electronic cigarette according to a first embodiment of the application. FIGS. 3 and 4 are respectively a schematic view and an explosive view of a structure for displaying a battery status of an electronic cigarette according to a second embodiment of the application. FIGS. 5 and 6 are respectively a schematic view and an explosive view of a structure for displaying a battery status of an electronic cigarette according to a third embodiment of the application. FIG. 7 is a schematic circuit diagram of an electronic cigarette provided in the application.

Key improvements of each of the structures for displaying the battery status of the electronic cigarette according to embodiments of the application are given as follows.

The structure for displaying the battery status of the electronic cigarette includes a light-emitting assembly and a control system.

The light-emitting assembly is arranged at a battery rod portion of the electronic cigarette and includes multiple light-emitting units arranged along an axial direction of the battery rod, where the multiple light-emitting units are for representing different electric quantities of a battery.

The control system is electrically connected to a battery of the electronic cigarette, and may independently control lighting and extinguishing of the multiple light-emitting units based on the battery status while the electronic cigarette is working, to visually reflect the battery status.

As illustrated from the above technical solution, in each of the structures for displaying the battery status of the electronic cigarette according to the embodiments of the application, the light-emitting assembly is arranged in the battery rod portion of the electronic cigarette; the multiple light-emitting units are arranged along the axial direction of the battery rod, where the multiple light-emitting units are for representing different electric quantities of the battery; and the control system independently controls the lighting and extinguishing of the multiple light-emitting units based on the battery status while the electronic cigarette is working. Hence, the battery status of the electronic cigarette may be visually displayed, and a user may easily acquire a battery condition and perform a reasonable arrangement of charging and usage, thereby improving the user experience.

Specifically, the control system includes a microprocessor, and an electric quantity monitoring module or a voltage monitoring module.

The electric quantity monitoring module or the voltage monitoring module may monitor the electric quantity or a voltage of the battery and may send a monitored battery status signal to the microprocessor.

The microprocessor may receive the battery status signal, and may control a lighting position of the light-emitting units of the light-emitting assembly based on the battery status signal. A process of lighting and extinguishing (which may be, for example, a lighting order and lighting time in addition to the lighting position) of the multiple light-emitting units of the light-emitting assembly is controlled by monitoring a change of the voltage of the battery or a change of the electric quantity of the battery during the usage of the electronic cigarette, to visually reflect the battery status of the electronic cigarette.

To further improve the above technical solution, the control system also includes an airflow sensor.

The airflow sensor is for monitoring a suction airflow of the electronic cigarette and sending a signal associated with the monitored airflow to the microprocessor.

The microprocessor may receive the signal associated with the airflow, and in case of receiving the signal associated with the airflow, the microprocessor may control the lighting position of the light-emitting units of the light-emitting assembly based on the battery status signal (the electric quantity or the voltage) monitored by the electric quantity monitoring module or the voltage monitoring module, thereby displaying the battery status timely while the user uses the electronic cigarette.

FIG. 7 is a schematic circuit diagram of the electronic cigarette. The microprocessor may control an led lamp display module (i.e., the light-emitting assembly) and an atomization device based on the airflow sensor and a monitoring structure of the voltage monitoring module.

In a preferred embodiment of the application, the microprocessor may further control the lighting position of light-emitting units of the light-emitting assembly based on the signal associated with the airflow, to simulate a shortening of a lighted cigarette.

Furthermore, the airflow sensor may detect the frequency and intensity of the suction airflow. The process of lighting and extinguishing, such as the lighting position, the lighting order and the lighting time, of lamps on a lamp panel is controlled by monitoring times of suctions of the electronic cigarette or the intensity of the airflow, to simulate the shortening of the lighted cigarette.

Specifically, the light-emitting assembly may be arranged on an outer surface of the battery rod, and may reflect the battery status or simulate the shortening of the lighted cigarette, by emitting light. Alternatively, the light-emitting assembly may be arranged between an inner wall of the battery rod and the battery of electronic cigarette, and may emit light outwardly through the battery rod, thereby guaranteeing the integrity of the outer surface of the battery rod.

The light-emitting assembly in each of the structures for displaying the battery status of the electronic cigarette according to the embodiments of the application is a flexible lamp panel or a rigid lamp panel. The multiple light-emitting units may be arranged in a length direction of the lamp panel.

Preferably, the multiple light-emitting units are arranged into circles in a radial direction of the electronic cigarette. Hence, both functions of simulating the lighted cigarette and displaying a power utilization condition may be realized.

In the first embodiment of the application, the light-emitting assembly is a scroll-like lamp panel 16 arranged between an inner wall of a battery rod 11 and a battery 13 of the electronic cigarette. An inner wall and an outer wall of the scroll-like lamp panel respectively fit with an outer wall of the battery 13 and inner wall of the battery rod 11. Multiple rows of LED lamps serving as light-emitting units are evenly spaced at the scroll-like lamp panel 16 in an axial direction of the scroll-like lamp panel 16, a structure of the LED lamps may be referred to FIGS. 1 and 2, where 12 is an atomizer, 14 is a microphone assembly, and 15 is a lamp cap.

The second embodiment of the application is illustrated in FIGS. 3 and 4. The light-emitting assembly is a surround-like lamp panel 26 having a helical whole shape, which is arranged between an inner wall of a battery rod 21 and a battery 23 of the electronic cigarette. An inner wall and an outer wall of the surround-like lamp panel respectively fit with an outer wall of the battery 13 and the inner wall of the battery rod 11. Multiple rows of LED lamps serving as light-emitting units are arranged at the surround-like lamp panel 26 in a length extending direction of the surround-like lamp panel 26.

As illustrated in FIGS. 5 and 6, in the third embodiment of the application, the light-emitting assembly includes a pcb lamp panel 341 and multiple miniature lamps 342 arranged in a length direction of the pcb lamp panel. The miniature lamps serve as lamps for simulating a lighted end of the cigarette, and both sides of the pcb lamp panel 341 may be retained in an installation groove provided on an inner wall of a lamp cap 35 of the electronic cigarette.

To further improve the above technical solution, the light-emitting assembly further includes a lamp for simulating an ash end of a lighted cigarette, the lamp for simulating the ash end being arranged at the side of the lamp cap. With the above configuration, the lamp for simulating the ash end lights up in case of each suction after a first display of the voltage or the electric quantity.

An electronic cigarette is further provided according to an embodiment of the application. A core improvement is that the electronic cigarette has the foregoing structure for displaying the battery status of the electronic cigarette. Hence, the battery status of the electronic cigarette may be visually displayed, and a user may easily acquire a battery condition and further perform a reasonable arrangement of charging and usage, thereby improving user experience.

A method for displaying a battery status of an electronic cigarette is further provided according to an embodiment of the application. A core improvement of the method is that, the method includes the following steps Si and S2.

In the step S1, the battery status of the electronic cigarette is monitored in case of detecting a switch-on of the electronic cigarette or detecting a suction airflow.

In the step S2, lighting and extinguishing of multiple light-emitting units arranged in a light-emitting assembly is controlled based on the battery status, where the multiple light-emitting units are arranged in an axial direction of a battery rod and are for representing different electric quantities of a battery. An electric quantity of the battery represented by a light-emitting unit remote from a suction end of the electronic cigarette is larger than an electric quantity of the battery represented by a light-emitting unit close to the suction end of the electronic cigarette.

To further improve the above technical solution, controlling the lighting and extinguishing includes:
controlling a first group of light-emitting units farthest away from the suction end of the electronic cigarette to light up if the battery status is in a sufficient range,
controlling a second group of light-emitting units located in a middle portion of the light-emitting assembly to light up if the battery status is in a moderate range, and
controlling a third group of light-emitting units closest to the suction end of the electronic cigarette to light up if the battery status is in an inadequate range.

According to an embodiment of the application, the first, second and third groups of light-emitting units are three groups of lamps successively arranged on a lamp panel from a location far from the suction end to a location close to the suction end, i.e., a distinguishing is achieved by a lighting position of the lamps. Alternatively, the first group includes all the light-emitting units, the third group includes a minority of light-emitting units close to the suction end, and the second group includes a majority of the light-emitting units close to the suction end; in other words, a process in which the battery status changes from sufficient to inadequate is more vividly simulated with a lighting area changing from big to small.

Preferably in the step S2, the brightness of a light emitted by a light-emitting unit far away from the suction end of the electronic cigarette is stronger than the brightness of a light emitted by a light-emitting unit close to the suction end of the electronic cigarette, thereby displaying the battery status more visually.

To further improve the technical solution, in the step S2, multiple light-emitting units are circularly arranged in a radial direction of the electronic cigarette to form a group of light-emitting units, and the light-emitting assembly is provided with several groups of light-emitting units arranged in the axial direction of the battery rod. Thus, both functions of simulating a lighted cigarette and displaying a power utilization condition may be realized.

In conclusion, in the electronic cigarette and the structure for displaying the battery status of the electronic cigarette provided in the application, a flexible lamp panel or a rigid lamp panel is provided on a surface of the electronic cigarette or inside the electronic cigarette; and the lighting position of lamps on the lamp panel is controlled based on a change of the voltage or electric quantity of the battery during the usage of the electronic cigarette. Hence, the battery status of the electronic cigarette may be visually displayed, and the user may easily acquire the battery condition and further perform a reasonable arrangement of charging and usage, thereby improving the user experience. The method for displaying the battery status of the electronic cigarette is further provided in the present application, where the method is visual, vivid and applicable to the foregoing structure.

The embodiments of the specification are described progressively; each embodiment emphasizes differences from other embodiments, and same or similar parts of the embodiments may be referred to each other.

Based on the above description of the disclosed embodiments, those skilled in the art are capable of carrying out or using the present application. Various modifications to these embodiments are obvious for those skilled in the art. The general principle defined herein may be applied to other embodiments without departing from the spirit or scope of the present application. Therefore, the present application is not limited to the embodiments disclosed herein, but should be in accordance with a broadest scope consistent with the principle and novel features disclosed herein.

1. A structure for displaying a battery status of an electronic cigarette, comprising:
a light-emitting assembly and a control system;
wherein the light-emitting assembly is arranged at a battery rod portion of the electronic cigarette and comprises a plurality of light-emitting units arranged in an axial direction of the battery rod, the plurality of light-emitting units being configured to represent different electric quantities of a battery; and
wherein the control system is electrically connected to the battery of the electronic cigarette, and is configured to independently control lightings and extinguishings of the plurality of light-emitting units based on the battery status when the electronic cigarette operates.

2. The structure for displaying the battery status of the electronic cigarette according to claim 1, wherein the control system comprises a microprocessor, and an electric quantity monitoring module or a voltage monitoring module;
the electric quantity monitoring module or the voltage monitoring module is configured to, monitor an electric quantity or a voltage of the battery and transmit a monitored battery status signal to the microprocessor; and
the microprocessor is configured to, receive the battery status signal and control, based on the battery status signal, a lighting position of the light-emitting units of the light-emitting assembly.

3. The structure for displaying the battery status of the electronic cigarette according to claim 2, wherein the control system further comprises an airflow sensor;
the airflow sensor is configured to, monitor a suction airflow of the electronic cigarette and transmit a signal associated with the monitored airflow to the microprocessor; and
the microprocessor is configured to, receive the signal associated with the airflow, and control, in case of receiving the signal associated with the airflow, the lighting position of the light-emitting units of the light-emitting assembly based on the battery status signal monitored by the electric quantity monitoring module or the voltage monitoring module.

4. The structure for displaying the battery status of the electronic cigarette according to claim 1, wherein the light-emitting assembly is arranged on an outer surface of the battery rod or is arranged between an inner wall of the battery rod and the battery of the electronic cigarette.

5. The structure for displaying the battery status of the electronic cigarette according to claim 4, wherein the light-emitting assembly is a flexible lamp panel or a rigid lamp panel.

6. The structure for displaying the battery status of the electronic cigarette according to claim 5, wherein the plurality of light-emitting units are arranged into circles in a radial direction of the electronic cigarette.

7. The structure for displaying the battery status of the electronic cigarette according to claim 6, wherein the light-emitting assembly is a scroll-like lamp panel arranged between the inner wall of the battery rod and the battery of the electronic cigarette, and a plurality of rows of LED lamps serving as the light-emitting units are arranged at the scroll-like lamp panel in an axial direction of the scroll-like lamp panel.

8. The structure for displaying the battery status of the electronic cigarette according to claim 5, wherein the light-emitting assembly is a surround-like lamp panel arranged between the inner wall of the battery rod and the battery of the electronic cigarette, and a plurality of rows of LED lamps serving as the light-emitting units are arranged at the surround-like lamp panel in a length extending direction of the surround-like lamp panel.

9. The structure for displaying the battery status of the electronic cigarette according to claim 5, wherein the light-emitting assembly comprises a pcb lamp panel and a plurality of miniature lamps arranged in a length direction of the pcb lamp panel, and two sides of the pcb lamp panel are retainable in an installation groove provided on an inner wall of a lamp cap of the electronic cigarette.

10. The structure for displaying the battery status of the electronic cigarette according to claim 5, wherein the light-emitting assembly further comprises a lamp for simulating an ash end of a lighted cigarette, the lamp for simulating the ash end being arranged at a side of a lamp cap.

11. An electronic cigarette, comprising a structure for displaying a battery status of an electronic cigarette, wherein the structure for displaying the battery status of the electronic cigarette comprises a light-emitting assembly and a control system,
the light-emitting assembly is arranged at a battery rod portion of the electronic cigarette and comprises a plurality of light-emitting units arranged in an axial direction of the battery rod, the plurality of light-emitting units being configured to represent different electric quantities of a battery, and
the control system is electrically connected to the battery of the electronic cigarette, and is configured to independently control lightings and extinguishings of the plurality of light-emitting units based on the battery status when the electronic cigarette operates.

12. A method for displaying a battery status of an electronic cigarette, comprising:
a step S1 of monitoring the battery status of the electronic cigarette in case of detecting a switch-on of the electronic cigarette or detecting a suction airflow; and
a step S2 of controlling, based on the battery status, lightings and extinguishings of a plurality of light-emitting units arranged in a light-emitting assembly, the plurality of light-emitting units being arranged in an axial direction of a battery rod and configured to represent different electric quantities of a battery, wherein an electric quantity of the battery represented by a light-emitting unit remote from a suction end of the electronic cigarette is larger than an electric quantity of the battery represented by a light-emitting unit close to the suction end of the electronic cigarette.

13. The method for displaying the battery status of the electronic cigarette according to claim 12, wherein controlling the lightings and extinguishings in the step S2 comprises:
controlling a first group of light-emitting units farthest away from the suction end of the electronic cigarette to light up if the battery status is in a sufficient range,
controlling a second group of light-emitting units located in a middle portion of the light-emitting assembly to light up if the battery status is in a moderate range, and
controlling a third group of light-emitting units closest to the suction end of the electronic cigarette to light up if the battery status is in an inadequate range.

14. The method for displaying the battery status of the electronic cigarette according to claim 12, wherein in the step S2, a brightness of a light emitted by the light-emitting unit remote from the suction end of the electronic cigarette is stronger than a brightness of a light emitted by the light-emitting unit close to the suction end of the electronic cigarette.

15. The method for displaying the battery status of the electronic cigarette according to claim 12, wherein in the step S2, a plurality of light-emitting units are circularly arranged in a radial direction of the electronic cigarette to form a group of light-emitting units, and the light-emitting assembly is provided with a plurality of groups of light-emitting units arranged in the axial direction of the battery rod.

16. The structure for displaying the battery status of the electronic cigarette according to claim 2, wherein the light-emitting assembly is arranged on an outer surface of the battery rod or is arranged between an inner wall of the battery rod and the battery of the electronic cigarette.

17. The structure for displaying the battery status of the electronic cigarette according to claim 3, wherein the light-emitting assembly is arranged on an outer surface of the battery rod or is arranged between an inner wall of the battery rod and the battery of the electronic cigarette.

18. The electronic cigarette according to claim 11, wherein the control system comprises a microprocessor, and an electric quantity monitoring module or a voltage monitoring module;
the electric quantity monitoring module or the voltage monitoring module is configured to, monitor an electric quantity or a voltage of the battery and transmit a monitored battery status signal to the microprocessor; and
the microprocessor is configured to, receive the battery status signal and control, based on the battery status signal, a lighting position of the light-emitting units of the light-emitting assembly.

19. The electronic cigarette according to claim 18, wherein the control system further comprises an airflow sensor;
the airflow sensor is configured to, monitor a suction airflow of the electronic cigarette and transmit a signal associated with the monitored airflow to the microprocessor; and
the microprocessor is configured to, receive the signal associated with the airflow, and control, in case of receiving the signal associated with the airflow, the lighting position of the light-emitting units of the light-emitting assembly based on the battery status signal monitored by the electric quantity monitoring module or the voltage monitoring module.

20. The electronic cigarette according to claim 11, wherein the light-emitting assembly is arranged on an outer surface of the battery rod or is arranged between an inner wall of the battery rod and the battery of the electronic cigarette.
